(19) United States
(12) Patent Application Publication
(10) Pub. No.: US 2013/0282333 A1
(43) Pub. Date: Oct. 24, 2013

(54) SERVICE PORT EXPLORER

(71) Applicants: TIMOTHY ANDREW MAST, Plain City, OH (US); KEVIN DALE STARR, Lancaster, OH (US); DANIEL JOSEPH OVERLY, Westerville, OH (US)

(72) Inventors: TIMOTHY ANDREW MAST, Plain City, OH (US); KEVIN DALE STARR, Lancaster, OH (US); DANIEL JOSEPH OVERLY, Westerville, OH (US)

(73) Assignee: ABB TECHNOLOGY AG, Zurich (CH)

(21) Appl. No.: 13/453,115

(22) Filed: Apr. 23, 2012

(51) Int. Cl. G06F 15/00

(52) U.S. Cl. 702/182

(57) ABSTRACT

Customer data is received via a secure communication tunnel connection by a device from one or more customer systems, the device and systems both physically located within a customer facility. Key performance indicator (KPI) data associated with the customer systems is generated by a processing unit of the device from the received customer data and displayed in a format appropriate to the received data and the generated KPI data, via selection and application of one or more automated service tools from a plurality of tools each sharing a common architecture infrastructure. The generated KPI data is visually displayed in a graphical user interface dashboard report to a service expert in a reporting format that is readily indicative of a resolution of a performance problem of the customer system to the service expert. In some examples the KPI reporting is transformative of the underlying received data, thereby maintaining confidentiality.

### FIELD OF THE INVENTION

Embodiments of the present invention relate to deploying on-site diagnostic analysis adaptable to different industrial processes through a common architectural framework.

### BACKGROUND

Service experts have long had methods for collecting and analyzing customer diagnostic information for troubleshooting industrial process implementations. These methods are very effective in the right expert's hands. Some are documented and engineers and other experts may be readily trained to implement them, but since specific implementations may occur only occasionally with regard to similar processes, data inputs and benchmarks, experts must often relearn an appropriate method and application for each new job.

Automation services may provide software and hardware to tools that automate known diagnostic methods for use by experts, making them consistent, repeatable, expeditious, and sometimes simpler, when applied to a given industrial process. However, when pluralities of different industrial processes are implemented within a plant or other large enterprise, problems arise in efficiently applying such automated diagnostic tools. Each process may require a different tool. Applying the different tools and as well as gathering information outputs from the tools generally requires a technician to travel to an on-site location, manually select appropriate tools, harmonize and interpret outputs from a variety of different software and hardware formats, and otherwise use expert discretion is selecting and managing the diagnostic process. Such on-site, expert management requirements defeat many of the efficiencies gained from the application of the automated diagnostic tools over manual expert technician services.

### BRIEF SUMMARY

In one embodiment of the present invention, a method that includes a processing unit receiving customer data from one or more systems of a customer via a secure communication tunnel connection to the customer system. The systems and the processing unit are physically located within a facility of the customer. Key performance indicator data associated with the customer system(s) is generated by the processing from the received customer data unit via application of an automated service tool that is appropriate to a format of the received data. The processing unit displays the generated key performance indicator data in a visual display format that indicates a performance quality attribute of the generated key performance indicator data with respect to a performance benchmark. In response to the determined performance gap exceeding a threshold, the processing unit visually displays the generated key performance indicator data in a graphical user interface dashboard report to a service expert that is in communication with the processing unit via a secure access communication link, wherein the generated key performance indicator data visually displayed in the dashboard report indicates a resolution of a performance problem of the customer system to the service expert. In response to an input from the service expert via the secure access communication link, the processing unit schedules a resolution to the performance problem indicated by the visually displayed generated key performance indicator data for implementing by the customer system.

In another embodiment, a system has a processing unit, computer readable memory and a tangible computer-readable storage device with program instructions, wherein the processing unit, when executing the stored program instructions, receives customer data from one or more systems of a customer via a secure communication tunnel connection to the customer system. The systems and the processing unit are physically located within a facility of the customer. Key performance indicator data associated with the customer system(s) is generated by the processing from the received customer data unit via application of an automated service tool that is appropriate to a format of the received data. The processing unit displays the generated key performance indicator data in a visual display format that indicates a performance quality attribute of the generated key performance indicator data with respect to a performance benchmark. In response to the determined performance gap exceeding a threshold, the processing unit visually displays the generated key performance indicator data in a graphical user interface dashboard report to a service expert that is in communication with the processing unit via a secure access communication link, wherein the generated key performance indicator data visually displayed in the dashboard report indicates a resolution of a performance problem of the customer system to the service expert. In response to an input from the service expert via the secure access communication link, the processing unit schedules a resolution to the performance problem indicated by the visually displayed generated key performance indicator data for implementing by the customer system.

In another embodiment, an article of manufacture has a computer-readable storage medium with computer readable program code embodied therewith, the computer readable program code comprising instructions that, when executed by a computer processing unit, cause the computer processing unit to receive customer data from one or more systems of a customer via a secure communication tunnel connection to the customer system. The systems and the processing unit are physically located within a facility of the customer. Key performance indicator data associated with the customer system(s) is generated by the processing from the received customer data unit via application of an automated service tool that is appropriate to a format of the received data. The processing unit displays the generated key performance indicator data in a visual display format that indicates a performance quality attribute of the generated key performance indicator data with respect to a performance benchmark. In response to the determined performance gap exceeding a threshold, the processing unit visually displays the generated key performance indicator data in a graphical user interface dashboard report to a service expert that is in communication with the processing unit via a secure access communication link, wherein the generated key performance indicator data visually displayed in the dashboard report indicates a resolution of a performance problem of the customer system to the service expert. In response to an input from the service expert via the secure access communication link, the processing unit schedules a resolution to the performance problem indicated by the visually displayed generated key performance indicator data for implementing by the customer system.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 is a diagrammatic illustration of an embodiment of a Service Port Explorer Service Delivery Device according to the present invention.

FIG. 2 is a flow diagram illustration of a solution methodology practiced by embodiments of the present invention.

FIG. 3 is a timeline bar graph illustration of attributes of embodiments of the present invention, contrasted with prior art attributes.

FIG. 4 is a bar graph illustration bar that contrasts estimates of the effort necessary for steps of the solution methodology of FIG. 2 by embodiments of the present invention, contrasted with the prior art.

FIG. 5 is a block diagram illustration of attributes of one embodiment of the present invention.

FIG. 6 is a block diagram illustration of process analysis and implementation via an embodiment according to the present invention.

FIG. 7 is a block diagram illustration of process analysis and implementation via an embodiment according to the present invention, as contrasted with prior art teachings.

FIG. 8 is a graphic illustration of a graphical user interface display according to the present invention.

FIG. 9 is a block diagram illustration of attributes of an embodiment according to the present invention.

FIG. 10 is a block diagram illustration of a computerized implementation of an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

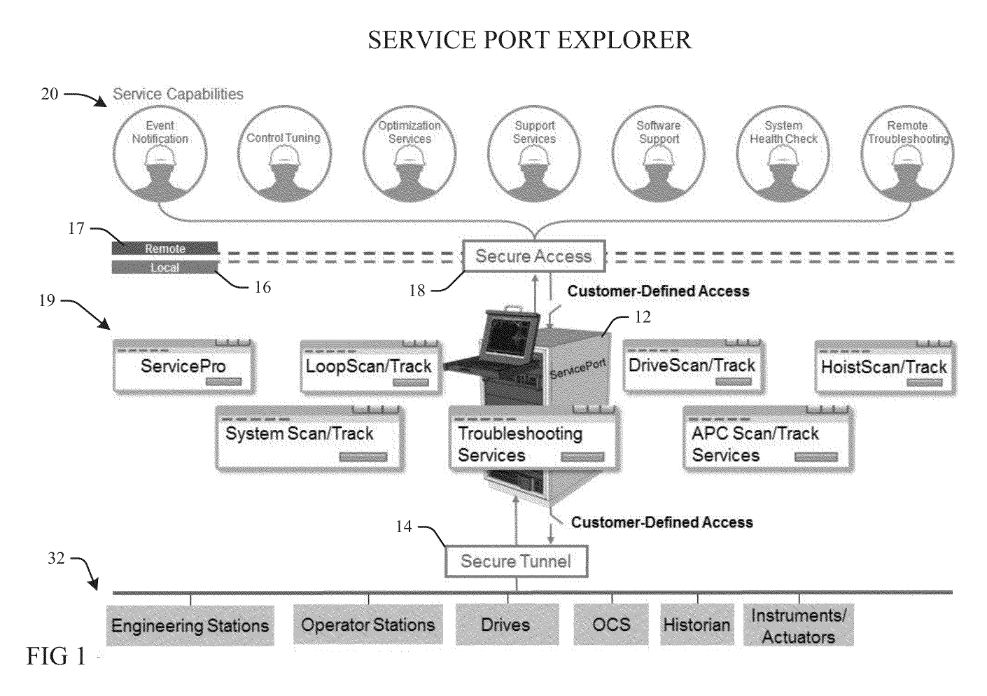

FIG. 1 illustrates a Service Port Explorer Service Delivery Device (Service Port Explorer Device) 12 installed on-site at a customer's plant or other local geographic location 16 in communication via a secure tunnel 14 to each of a plurality of customer systems or process elements 32 in a secure manner on the local site 16. The Service Port Explorer Device 12 is also accessed by outside service experts through a remote-enabled secure access interface 18, and thereby outputs reports, alarms, service plans, etc., that it generates from customer data received via the secure tunnel 14 from the customer systems or process elements 32 by use of one or more automated service tool applications 19. The customer data is and generally kept on-site and confidential from the experts located off-sight (at one or more remote locations 17), wherein the generated output information is used by the off-sight service experts to provide additional off-site analysis or services 20.

More particularly, the Service Port Explorer Device 12 is a robust node that provides a software “explorer” gateway to services that may be configured and deployed either on-site 16 or off-site 17 by off-site technicians through secure, remote connectivity 18. Said off-site technicians cannot not review or receive confidential customer data through the secure access 18 unless the customer wishes to enable this capability. Instead, the Service Port Explorer Device 12 essentially transforms the collected data into reports and other data representations that are informative of process performances without divulging the underlying raw data. In this fashion off-site experts may remotely view, analyze, diagnose and correct on-site customer issues through outputs generated by the Service Port Explorer Service Delivery Device 12 while customer data input may be kept confidential and on-site.

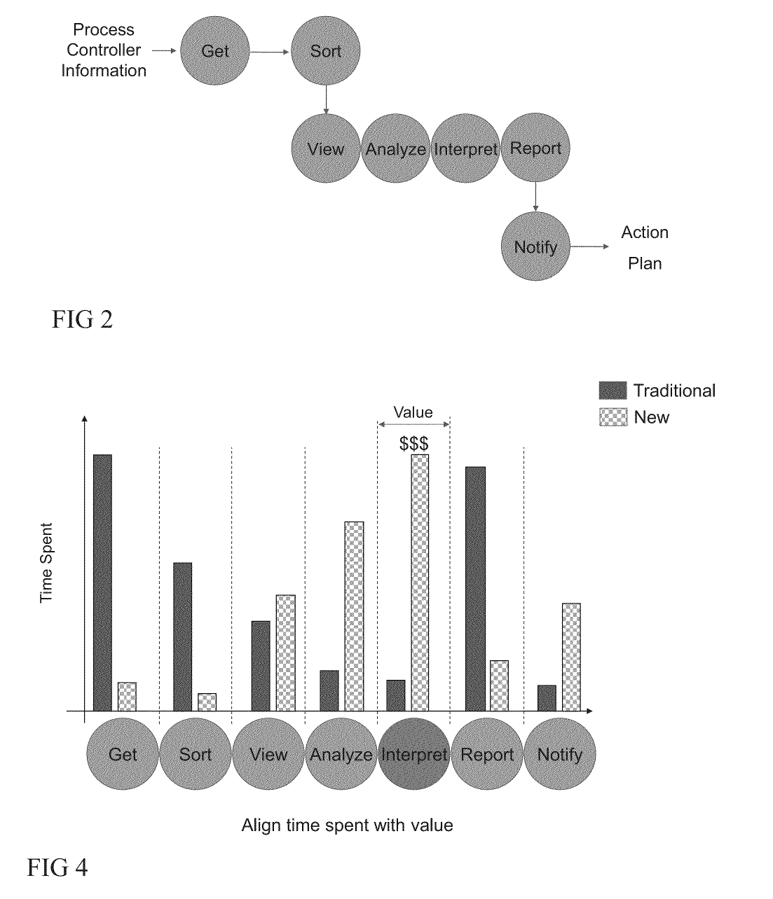

FIG. 2 illustrates a solution methodology practiced by embodiments of the Service Port Explorer Device 12. Data from customer process controllers or other process elements (32, FIG. 1) is acquired (Get) and sorted (Sort) for use in analysis. In the prior art the acquired/sorted data is analyzed by an expert, engineer or other service technician (View, Analyze, Interpret and Report), who determines a solution to improve system performance, and the determined solution presented as an action plan to the customer (Notify). The goal of any troubleshooting effort is to quickly diagnose the problem and provide the necessary corrective action of implementation. However, the effort necessary to determine the most accurate course of action is overlooked. This often results in time being spent in areas of the solution tree that are not cost effective and in turn results in either a wrong solution or a course of corrective action that does not impact the problem being solved.

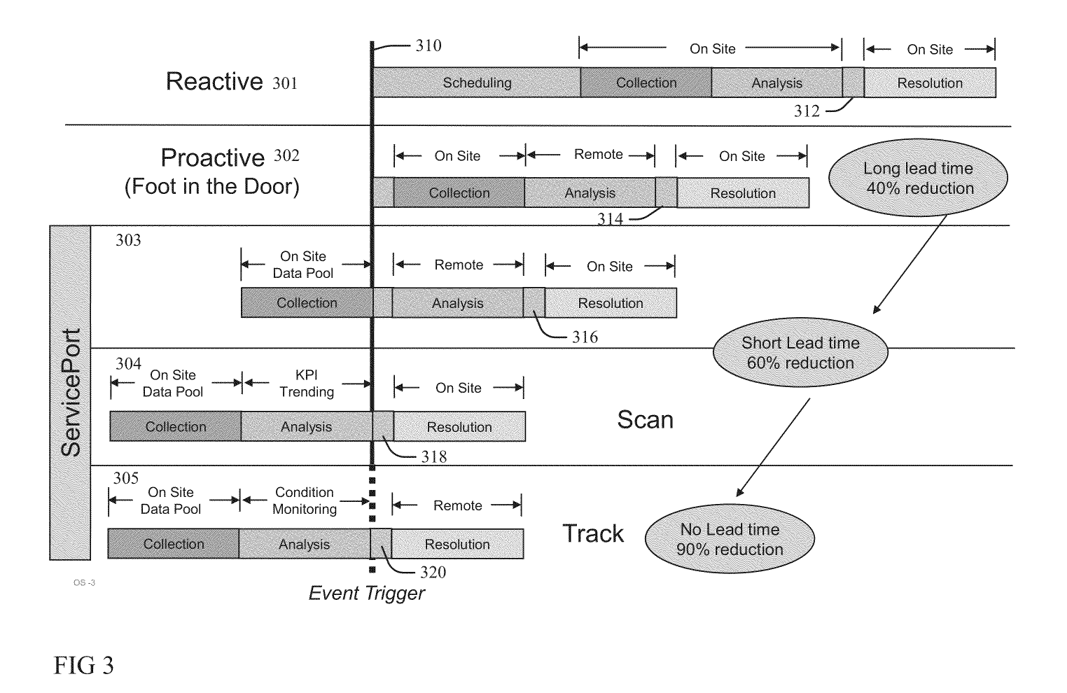

FIG. 3 is a timeline bar graph that illustrates differences in total times required by the Service Port Explorer Device 12 and other the prior art processes to diagnose and resolve problems in a customer enterprise, wherein time elapses as one progresses along the horizontal lines from left to right. The top area of the FIG. 3 chart shows a typical prior art “Reactive” process 301 wherein services are not requested or provided until the occurrence of an event trigger 310 which notifies the customer or service provider that some adjustment to a system process is required or in order. The event trigger 310 prompts an initial scheduling period in the Reactive process 301 that is required to get the requested expert services in place on site. Once on site, the expert performs data collection and analysis to identify performance gaps or other problems useful in identifying a solution for a problem indicated by the event trigger 310, and which ultimately enables scheduling of the solution for implementation and resolution (thus creating another, shorter scheduling period 312 between the analysis and resolution stages). A sum of the initial scheduling period and the collection and analysis periods defines a total lead time required between the event trigger 310 and the first indication of a solution appropriate for scheduling at 312.

The FIG. 3 chart also shows a “Proactive” process 302, wherein an agreement between an expert service provider and the customer for diagnosis and solutions services is already in place. This greatly shortens the scheduling time required to implement the on-site data collection stage compared to the Reactive process. (This example contemplates that the Proactive analysis stage takes place remotely, off-site, though in other examples the analysis may be completed on site.) The Proactive process provides a 40% reduction in the total time to implement the resolution after the event trigger 310 compared to the Reactive process, though the lead time required for the expert to collect and analyze the data in order to determine a solution for scheduling at 314 after the event trigger 310 is still relatively long.

The FIG. 3 chart also shows three diagnosis and resolution implementations 303, 304 and 305 provided by the Service Port Explorer Device 12 of FIG. 1. In each of the three examples on-site data collection is already being performed by the Service Port Explorer Device 12 on an unsupervised basis prior to the event trigger 310 occurrence. This saves lead time and also provides resource efficiencies over the prior art processes by freeing up service experts from the data collection process. In the first (top) Service Port Explorer Device example 303 the event trigger 310 immediately causes scheduling and implementation of the data analysis service by the expert, which is enabled by the on-site data collection is already being performed by the Service Port Explorer Device 12 prior to the event trigger 310: this example provides a 60% reduction in the total time required to implement the resolution after the event trigger 310 compared to the Reactive process, and a shorter the lead time to schedule the resolution implementation at 316 after the event trigger 310.

Two other Service Port Explorer Device examples 304 and 305 shown in the chart of FIG. 3 each perform on-site data collection and analysis of the collected data on an unsupervised basis prior to the event trigger 310 occurrence, via Key Performance Indicators (KPI) trending in the first example 304, and via condition monitoring analysis in the second example 305. More particularly, automated service tools are known that may quickly and consistently capture data from process control systems, and analyze that data to produce KPIs from which conclusions could be drawn. By standardizing each of a plurality of such KPI tools and offering them through a consistent interface the Service Port Explorer Device 12, the KPI process example 304 enables engineers with varying levels of experience to effect the automated collection and analysis of data to meaningfully present the data with respect to KPI's and other benchmarks via graphs, table and other analysis representations generated by the Service Port Explorer Device 12, providing a breakthrough in engineering services with respect to repeatability.

The process examples 304 and 305 provide resource efficiencies by freeing up service experts from the data analysis process, requiring neither remote nor on-site supervision or execution of the analysis processes. Lead times are also eliminated in scheduling and implementing a resolution after the event trigger 310: as the analysis is being performed on an on-going, continual or periodic basis, graphs, performance gap indicators or other displays of KPI analysis outputs may be presented to an expert immediately upon the trigger event 320 occurrence. In some examples a quick review of the generated KPI data displays by a skilled service expert will immediately suggest or indicate a resolution to a problem that has caused the event trigger 320, and thus the resolution may be essentially already identified and ready to be scheduled for implementation by the service expert immediately upon the occurrence of the event trigger 310 at 318 and 320. In other examples the analysis output may directly indicate an exact, ready-to-implement resolution: in such cases the automated tool may automatically schedule a resolution implementation immediately upon the event trigger 320, wherein the service expert may validate, confirm or intervene in the scheduled implementation after further review, interpretation and analysis of the displayed KPI reporting. Thus, the automated analysis embodiments 304 and 305 may provide a 90% reduction in the total time required to implement the resolution after the event trigger 310, compared to the prior art Reactive process 301.

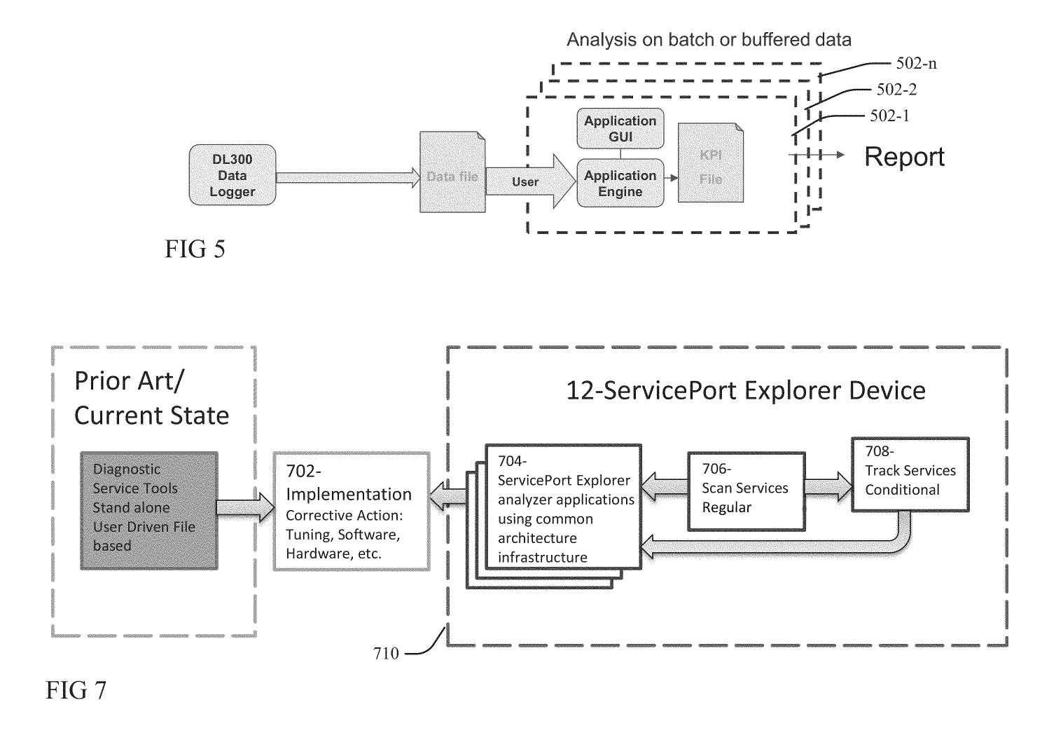

FIG. 4 provides a bar chart that contrast estimates of the effort necessary for each step of the prescribed solution tree of FIG. 2 by using the processes 305 and 307 of FIG. 3 implemented by Service Port Explorer Device 12 (depicted by the “new” striped bar elements) with conventional, prior art service expert processes and systems (depicted by the “traditional,” solid bar elements). The Service Port Explorer Device 12 much more quickly and efficiently executes the data gathering (Get and Sort) efforts. Further, by performing each of the View, Analyze, Interpret and Report efforts on an unsupervised basis, more expensive time otherwise spent by service experts on these KPI determination and comparison efforts is saved, freeing up the experts to perform higher value non-clerical services that align to their expertise. A service technician or other person skilled in the area of process automation utilizing the Service Port Explorer Device 12 is able to analyze much more data information (for example, 80 to 100 times more information) in a same time as previously allotted under prior art servicing processes that rely upon management of said processes by the expert himself. This capability becomes much more powerful within the overall Service Port Explorer Device 12 whereby several applications may be installed and implemented within the Service Port Explorer Device 12 using a common infrastructure, yet wherein each application may be personalized for a specific customer need, for example based on the problems the customer needs analyzed and performance issues that need to be solved.

The Service Port Explorer Device 12 industrial framework supports multiple system and/or process applications that may be uniquely tailored to customer application requirements. FIG. 5 illustrates one example of on-site data collection tool implemented within the Service Port Explorer Device 12 via a DL300 Data Logger, an automated tool provided by ABB Group. The DL300 Data Logger is used during transitions (such as grade changes) to expose discrete events, and that captures data constantly in a buffer so that when a discrete event occurs, the tool has significant data before and after the event, enabling the analysis phase to more meaningfully analyze and address the source of trouble. Said collected data is thus provided in a file to the each of a plurality of appropriate application analysis engines or tools 502 via a user-defined format appropriate to said tool(s), for example to any one or more of 502-1, 502-2, through 502-n of n available tools. A graphical user interface (GUI) is provided to enable a service expert to engage the each of the tools 502 via the secure access portal (18, FIG. 1). A KPI file is generated by each tool 502 in an analysis phase for use in monitoring, tracking and reporting out KPI data to a customer and/or service expert, which in some examples may itself quickly and readily indicate a resolution for implementation (such as discussed above with respect to FIG. 3).

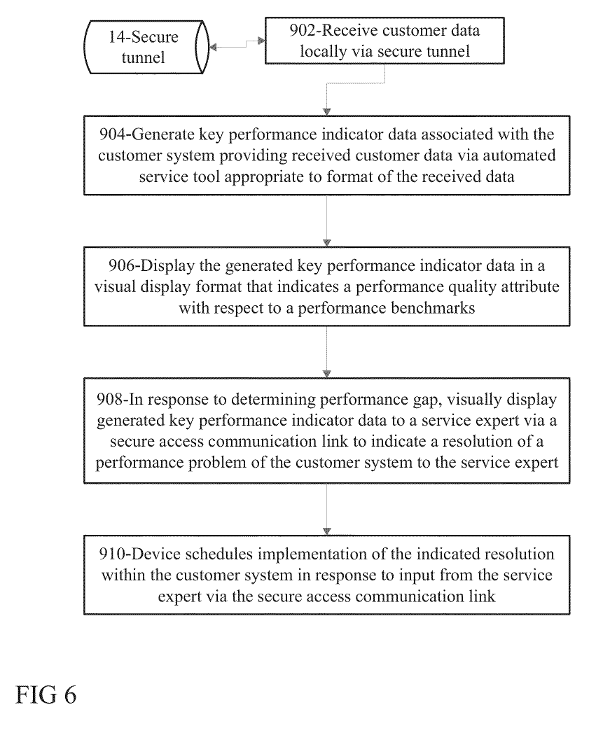

FIG. 6 is a block diagram illustration of a method according to the present invention, in view of FIGS. 1-5 as discussed above. At 902 customer data is received by a processing unit of a Service Port Explorer Device (for example, the device 12 of FIG. 1) from one or more systems of a customer via a secure communication tunnel connection, wherein the customer systems and the Service Port Explorer Device processing unit are each physically located within a facility of the customer. At 904 the device processing unit generates key performance indicator data associated with the customer system providing the received customer data, via application of an automated service tool that is appropriate to a format of the received data.

At 906 the device processing unit displays the generated key performance indicator data in a visual display format that indicates a performance quality attribute of the generated key performance indicator data with respect to one or more performance benchmarks, for example by conveying a performance gap between the generated key performance indicator data and a performance benchmark. At 908, in response to determining that a performance gap between the generated KPI data and a quality benchmark exceeds a threshold, the device processing unit visually displays the generated key performance indicator data in the format generated at 906 in a graphical user interface dashboard report to a service expert that is in communication with the processing unit via a secure access communication link, wherein the generated key performance indicator data is visually displayed in the dashboard report so as to indicate a resolution of a performance problem of the customer system to the service expert. In response to an input from the service expert via the secure access communication link, at 910 the device processing unit schedules implementation of the indicated resolution within the customer system. The indicated resolution scheduled at 910 may be determined by the expert from review of the information displayed 908, and directly entered and scheduled by the expert; or the indicated resolution may be automatically generated and scheduled by the device processing unit at 908, which is validated or otherwise confirmed for implementation by the service expert at 910. It is noted that the method of FIG. 6 may be practiced when the service expert is in a location that is physically remote from the customer facility through a remote connection (for example, via the secure access 18, FIG. 1).

More particularly, in the prior art the appropriate automated diagnostic tools must be manually identified and selected by a service expert through experience and discretion. As illustrated in FIG. 7, such prior art prior tools are generally stand-alone and each have their own physical footprint, expense, unique navigation, visualization and reporting requirements, wherein analysis and corrective action implementations are driven directly by the service tech or user and based on file data collected for that tool directly by said user or tech in response to a triggering event. In contrast, the Service Port Explorer Device 12 is more cost effective, performing unsupervised, regular scanning at 706 of one or more customer services through one or more of a plurality of analyzer application tools 704 that each use a common architecture infrastructure within one physical device footprint 710, and which also may track performance of scanned services relative to conditional benchmarks and thresholds at 708, wherein meeting certain benchmarks may automatically trigger designated reporting or corrective actions almost immediately upon determination of a triggering event. The Service Port Explorer Device 12 also provides for expert human intervention and interpretation through tuning and corrective actions with respect to software or hardware in an Implementation phase 702.

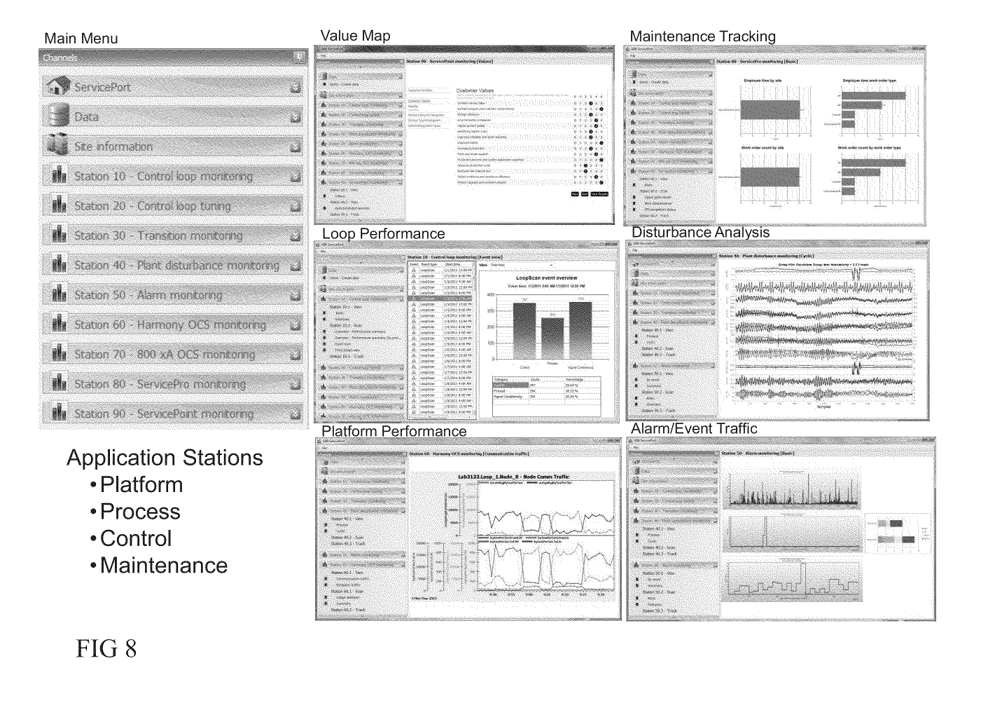

The Service Port Explorer Device 12 may provide a plurality of system and process optimization applications that increase the decision making throughput of an engineer skilled in the fundamentals of control theory in the areas of process controller performance and process interactions. FIG. 8 illustrates a plurality of different examples of individual tool output data presentations (at 906, FIG. 6), including Value Map, Maintenance Tracking, Loop Performance, Disturbance Analysis, Platform Performance and Alarm/Event Traffic graphic reports. Each presents different information to a service technician, accessible and displayed within a common GUI software application display, and follows a common framework method of data analysis that is readily engaged by the expert through the GUI. By providing a variety of different automated tools through a common framework this embodiment allows a user to be more effective and efficient in the accurate analysis of process issues related to control loop and process interactions, relative to prior art techniques wherein an expert must individually select and apply each different tool, and then still find some way to meaningfully compared the data generate by each tool.

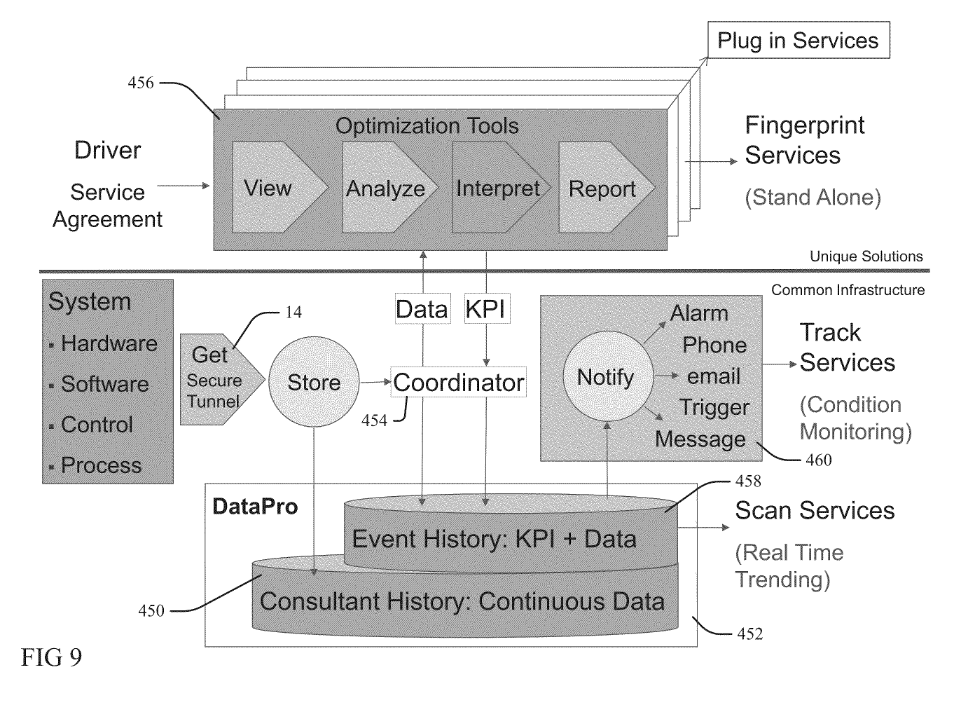

FIG. 9 illustrates attributes of one example of a Service Port Explorer Device 12. A common infrastructure is provided, wherein customer process data is continually (or periodically) acquired from one or more processes of an overall industrial process through the secure tunnel 14, stored in a continuous data store 450 of a Scan Services component 452 and provided to a coordinator element 454 to provide real-time trending data. The coordinator 454 selects and engages one or more of a plurality of optimization tools 456 to view, analyze and interpret the acquired data for an associated process or asset, wherein the format of data inputted to each of the tools 456 may be very different. The optimization tools 456 are unique solutions driven through a service agreement via a plurality of individual plug-in services, and may each provide stand-alone automated tools services, such as Fingerprint Services provided by the ABB Group.

A selected and engaged optimization tool 456 generates KPI data which is stored in association with the acquired data in an event history store 458 in the Scan Services component 452. The KPI data files are aligned or associated with a particular customer asset that is monitored through scan and tracking services. Each tool (or channel) 456 in the Service Port Explorer Device 12 has a visualization component that displays the KPI results (for example, through the dashboard view of FIG. 8) wherein someone skilled in the art of troubleshooting may look at the visualized information and conclude whether an associated customer asset is in good condition or if it needs improvement.

In an analysis stage mathematical models are used to capture the performance gap between good and bad visualized performances, and for the Scan Services component 452 to measure the performance gap. Track services are provided through monitors that track the performance gap and compare it to benchmarks and thresholds through logical rules, which may trigger alerts (at 908, FIG. 6) through the Notify component 460 that notifies an appropriate customer or service expert entity when the gap grows too large or is otherwise of concern relative to the benchmarks and thresholds. Tracking tools may track how many times a given rule has been violated, wherein a service expert may login to a dashboard (such as illustrated in FIG. 8) to readily determine what is failing most often and quickly move forward in troubleshooting. Raw data inputs and the determined KPI's and condition monitors are thus tied together by the Service Port Explorer Device 12, enabling a service expert to quickly explore their causal relationships through its GUI interface.

In one aspect results reported out to remote entities by the Service Port Explorer Device 12 may be a transformation or other representation of the acquired customer data into specialized reports that are representative of the data, but that do not directly contain or disclose the underlying data point inputs used to generate the reported data. Thus, customer data confidentiality may be maintained even if security attributes of the secure access link 18 (FIG. 1) are compromised, such as through intentional efforts to defeat security systems or via negligence in maintaining security protocols, if the KPI data reports generated and displayed at 906 (FIG. 6) do not provide direct access for the service expert to the received customer data used to generate the reports and displays. Such data transformations may be in quantity or timeframe: for example, data from a large plurality of data points collected continuously over a time period may be used to generate a graph of discrete KPI performances associated with or inferred from the data points at certain time periods during the period, or at the end of the time period.

Moreover, remote connections to customer systems are generally required in the prior art to acquire the data and generate KPI for system performance determinations, inherently presenting data security risk and other exposures for the customer data and equipment. In contrast, KPI analysis and tracking is automatically performed by the Service Port Explorer Device 12 on site and wholly contained within the device, without the need for any remote direction or access by outside service experts. In some embodiments the secure access portal 18 element may be disabled or omitted to enhance data security. In other embodiments the secure access portal 18 is connected to the customer process on site and allows remote experts to connect only to the proprietary, unique Service Port Explorer Device 12 hardware and to draw KPI data directly from it, without directly connecting to the customer processes or the individual data points used to generate the KPI data: the original customer data point data need not be directly accessible to a service expert, thus affording additional options in protecting the customer's data from inadvertent disclosure. Customers may be given the ability to define the level of security that they want, for example to further limit the data that may be accumulated or reported out or is otherwise accessible from the Service Port Explorer Device 12 through the secure access 18. Thus with fully user-defined security features, the on-site Service Port Explorer Device 12 node acts as a service coordinator device that supports the scanning and monitoring of a variety of system management processes while maintains confidentiality of underlying client data.

The Service Port Explorer Device 12 is a single point for implementation of a plurality of service solutions, a portal through which preventive, corrective and optimization services can be delivered quickly and cost-effectively and that provides access to the latest diagnostics and remote-enabled services as they are developed. System processes supported include system configuration, preventive and corrective maintenance, work order tracking, spare parts management, system diagnostics, condition monitoring, corrective implementation, service scheduling with additional advanced service applications for system and process optimization services, and still other services suitable for implementation will be apparent to one skilled in the art. Engineers and service personnel may thereby centrally connect to customer systems or processes in a secure manner to locally or remotely view, analyze, diagnose and correct customer issues. The Service Port Explorer Device 12 industrial framework further supports multiple system and/or process applications that may be uniquely tailored to customer application requirements.

The Service Port Explorer Device 12 offers customers and engineers the ability to support multiple system and process analyzer applications all within a common industrial framework (software/hardware container) that is uniquely tailored to a specific customer's unique needs (customer personalized explorer). No longer is there a need to have separate analyzer applications that are all stand-alone with their own physical foot-print space and cost requirements, as the Service Port Explorer Device 12 applications share common software infrastructure for view, analyze, report interpret and storage of data. In addition, the overall explorer user interface may be customized to specific customer needs.

Each customer may have different applications (stations) installed for a personalized Service Port Explorer Device 12 user unique interface, while at the same time each application may use a common infrastructure for many of the application tasks such as view, analyze, report, interpret and store data. In the example of FIG. 1 customer processes and elements 32 include engineering stations, operator stations, customer drives, OCS (Open Control System) components, historians and a variety of instruments and actuators. The common platform allows for multiple system and process applications as well as service bundling customized for customer needs: no longer is there a need to have separate analyzer applications that are all stand-alone with their own physical foot-print space and cost requirements.

The Service Port Explorer Device 12 allows for remote troubleshooting and correction of customer issues utilizing the secure access connection 18 to the customer's local network 16. In the prior art process experts must travel from site to site with the correct automated service tools and unique connectivity hardware to expedite customer data collection. The Service Port Explorer Device 12 enables such unique hardware to remain at the customer site 16 as implemented by the Service Port Explorer Device 12, making it possible for an expert to access and analyze data remotely and fix the customer problem, even when off-site. Cost and other efficiencies are realized as travel time and costs are eliminated, and the analysis may also be performed more often, on a regularly scheduled basis, in accordance with customer needs.

In some embodiments the Service Port Explorer Device 12 is incorporated into a control system personal computer (PC) or other programmable device used to provide system configuration tools on it, thereby delivering the system configuration tools as well as providing installation and commissioning tools for startup in the same device that can later be used to deliver remote system and process optimization once a plant or other industrial facility is in normal operation.

In one aspect the Service Port Explorer Device 12 provides cable box functionality: similar to a television programming delivery unit that is part of a cable (or satellite) television delivery system, one access connection (or “cable”) box is installed into the customer facility with secure access to the customer's system data that translates this data into multiple streams, or “channels” of programming to provide optimization services via a series of platform-independent, non-invasive services that can be applied to any automated process. A three step methodology (diagnose, implement, and sustain) may thus be applied to the task of control system auditing and tuning. The diagnose phase includes benchmarking existing performance to provide a basis for evaluating and identifying improvement opportunities. A resulting implementation plan revealed to an expert by review of the KPI reports, or automatically determined by one or more of the tools, may thus identify step-wise corrective activities for performance improvement, and associated financial benefits. Once improvements have been achieved, sustaining services (such as provided by ABB Scan & Track remote-enabled tools), utilizing on-site and remote-enabled services, may provide the means to maintain process improvements and potentially continue the improvement process. Examples of categories of such “channels” or “stations” of content include: system configuration, preventive and corrective maintenance, service scheduling, work order tracking, spare parts management and ordering, system optimization, process optimization, condition monitoring, event notification, support services, alarm and event notification, control tuning, software support, system health checks and remote troubleshooting, and still others will be apparent to one skilled in the art.

Examples of automated applications provided by ABB Group and appropriate for offering through embodiments of the Service Port Explorer Device 12 include:
a. An MD Analyzer that provides automated analysis of process controls that control linear MD (or “machine-direction”) parameters in a production process.
b. A CD Analyzer that provides automated analysis of process controls that control cross-linear or CD (“cross-direction”) parameters in a production process.
c. HarmonyS can & HarmonyTrack, which implement improvement actions and provide long-term, sustaining service to maximize control system performance, and optimize process performance. Harmony Optimization Services may also be incorporated to help customers manage their control system and prevent system deterioration or unpredictable system performance.
d. Loop Performance Optimization (LoopScan & LoopTrack) Benchmarking, correction and sustaining services that improve system performance. Control Loop Performance Optimization services improve process control performance by identifying and removing loop performance issues and achieving improvements through diagnostic, corrective and long-term continuous improvement activities. Proprietary software tools simplify complex loop data analysis, and troublesome loops are identified through combined data collection, model identification, feedback tuning, feed-forward tuning and controller simulation.

The Service Port Explorer Device 12 provides for remote, repeatable service benefits to customers and service providers through easy and fast system and process optimization from experts at any time, from anywhere in the world. Culturally, the Service Port Explorer Device 12 changes the service interaction between customers and service providers, presenting easy access to a wide variety of services that customers may never have used before, and making it easy for them to evaluate and acquire them. Its ability to collect and evaluate system and process data from competitive systems increases the customers' range of service options, as well as increasing service provider attractiveness. The level and range of service availability and access maximizes process automation lifecycle, allowing services to be delivered quickly and more cost-effectively than is available by traveling to each site for each service application as the prior art otherwise requires, which is good for the long-term success of both customers and service providers.

The Service Port Explorer Device 12 secure access interface 18 provides a secure portal through which customers may directly access configuration tools, diagnostic applications, improvement activities, and performance-sustaining troubleshooting scanning software that deploys agreed-upon actions. A service provider may also connect to a local site 16 customer system through the Service Port Explorer Device 12, which itself resides at the local customer site 16, and directly implement fixes to diagnosed problems.

In the prior art services methods may only be effective in the hands of a limited number of knowledgeable experts, or for a limited number of customer processes. In contrast, automated advanced remote services made available via the Service Port Explorer Device 12 may capture and analyze data so effectively that they may be used by less experienced engineers for multiple customer processes, reducing the time needed to capture and analyze data at customer sites, and allowing service provider to more efficiently and effectively address customer issues.

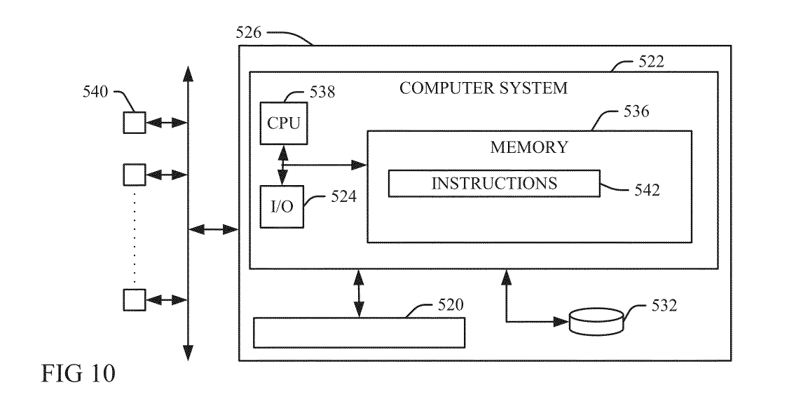

Referring now to FIG. 10, an exemplary computerized implementation of an embodiment of the present invention includes a computer system or other programmable device 522 in communication with customer system data sources 540. Instructions 542 reside within computer readable code in a computer readable memory 536, or in a computer readable storage system 532, or other tangible computer readable storage medium that is accessed through a computer network infrastructure 526 by a processing unit (CPU) 538. Thus, the instructions, when implemented by the processing unit (CPU) 538, cause the processing unit (CPU) 538 to generate KPI data outputs in response to customer system element data inputs and compare them to benchmarks in a fully automated and unsupervised basis as described above with respect to FIGS. 1-8.

Embodiments of the present invention may also perform process steps of the invention on a subscription, advertising, and/or fee basis. That is, a service provider could offer to integrate computer-readable program code into the computer system 522 to enable the computer system 522 to generate KPI data outputs in response to customer system element data inputs and compare them to benchmarks in a fully automated and unsupervised basis as described above with respect to FIGS. 1-9. The service provider can create, maintain, and support, etc., a computer infrastructure such as the computer system 522, network environment 526, or parts thereof, that perform the process steps of the invention for one or more customers. In return, the service provider can receive payment from the customer(s) under a subscription and/or fee agreement. Services may comprise one or more of: (1) installing program code on a computing device, such as the computer device 522, from a tangible computer-readable medium device 520 or 532; (2) adding one or more computing devices to a computer infrastructure; and (3) incorporating and/or modifying one or more existing systems of the computer infrastructure to enable the computer infrastructure to perform the process steps of the invention.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the Figures, may be distinguished or otherwise identified from others by unique adjectives (e.g., a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
receiving by a processing unit customer data from a system of a customer via a secure communication tunnel connection to the customer system, wherein the customer system and the processing unit are physically located within a facility of the customer;
generating by the processing unit key performance indicator data associated with the at least one customer system from the received customer data via application of an automated service tool that is appropriate to a format of the received data;
displaying by the processing unit the generated key performance indicator data in a visual display format that indicates a performance quality attribute of the generated key performance indicator data with respect to a performance benchmark;
in response to determining that a performance gap between the generated key performance indicator data and the performance benchmark exceeds a threshold, the processing unit visually displaying the generated key performance indicator data in the visual display format to a service expert in a remote location that is physically remote from the customer facility via a secure access communication link with the processing unit, wherein the generated key performance indicator data is visually displayed so as to indicate a resolution of a performance problem of the customer system to the service expert; and
in response to an input from the service expert via the secure access communication link, scheduling by the processing unit a resolution to the performance problem indicated by the visually displayed generated key performance indicator data for implementing by the customer system.

2. The method of claim 1, wherein the processing unit is contained within a device infrastructure container that comprises a plurality of different automated service tools comprising the automated service tool and that each receive different data formats comprising a first data format and a second data format that is different from the first data format, wherein the automated service tool is appropriate to receive and process the first data format and another of the plurality of different automated service tools is appropriate to receive and process the second data format;
wherein the customer system is comprised within a plurality of different customer systems that are each physically located within the customer facility and in secure communication with the processing unit via the tunnel connection, and the received customer data comprises first data from a first of the customer systems in the first data format and second data from a second of the customer systems in the second data format; and
wherein the step of generating the key performance indicator data comprises generating by the processing unit first key performance indicator data associated with the first system associated with the first data in the first data format via application of the automated service tool, and generating by the processing unit second key performance indicator data associated with the second system associated with the second data in the second data format via application of the another automated service tool that is appropriate to second data format.

3. The method of claim 1, wherein the step of generating the key performance indicator data associated with the customer system from the received customer data further comprises transforming received customer data into a data report that is informative of a process performance without providing direct access for the service expert to the received customer data.

4. The method of claim 2, further comprising:
the processing unit automatically generating an automated resolution as the indicated resolution in response to determining that the performance gap between the generated key performance indicator data and the performance benchmark exceeds the threshold; and
the processing unit generating an event trigger alert to the service expert or the customer and scheduling the automatically generating automated resolution for the implementing by the customer system in response to the determined performance gap exceeding the threshold; and
wherein the input from the service expert via the secure access communication link, validates or intervenes in the scheduled implementation.

5. The method of claim 2, wherein the step of analyzing the generated key performance indicator data to determine the performance gap between the generated key performance indicator data and the performance benchmark comprises the processing unit using a mathematical model to capture a performance gap between a good visualized performance and a bad visualized performance.

6. The method of claim 2, wherein the first and second customer systems are different services chosen from a plurality of services comprising system configuration, preventive and corrective maintenance, service scheduling, work order tracking, spare parts management and ordering, system optimization, process optimization, condition monitoring, event notification, support services, alarm and event notification, control tuning, software support, system health checks and remote troubleshooting services.

7. The method of claim 6, wherein the automated tool and the another automated tool are different tools chosen from a plurality of tools comprising:
a machine-direction analyzer that provides automated analysis of process controls that control linear parameters in a production process;
a cross-direction analyzer that provides automated analysis of process controls that control cross-linear parameters in a production process; and
a service management tool that applies best practices as a function of historical information data.

8. The method of claim 1, further comprising:
integrating computer-readable program code into a computer system comprising a processing unit, a computer readable memory and a computer readable tangible storage medium, wherein the computer readable program code is embodied on the computer readable tangible storage medium and comprises instructions that, when executed by the processing unit via the computer readable memory, cause the processing unit to perform the steps of generating the key performance indicator data, displaying the generated key performance indicator data in the visual display format that indicates the performance quality attribute of the generated key performance indicator data with respect to the performance benchmark to the service expert in response to the determining that the performance gap between the generated key performance indicator data and the performance benchmark exceeds the threshold so as to indicate a resolution of a performance problem of the customer system to the service expert, and the scheduling the resolution to the performance problem indicated by the visually displayed generated key performance indicator data for implementing by the customer system in response to the input from the service expert via the secure access communication link.

9. A diagnostic system, comprising:
a processing unit in communication with a computer readable memory and a tangible computer-readable storage medium within a container infrastructure that is physically located within a facility of a customer;
wherein the processing unit, when executing program instructions stored on the tangible computer-readable storage medium via the computer readable memory:
receives customer data from a system of a customer via a secure communication tunnel connection to the customer system, wherein the customer system is physically located within the customer facility;
generates key performance indicator data associated with the customer system from the received customer data via application of an automated service tool that is appropriate to a format of the received data;
displays the generated key performance indicator data in a visual display format that indicates a performance quality attribute of the generated key performance indicator data with respect to a performance benchmark;
in response to the determined performance gap exceeding a threshold, visually displays the generated key performance indicator data in a graphical user interface dashboard report to a service expert that is in a remote location that is physically remote from the customer facility and the container infrastructure and in communication with the container infrastructure via a secure access communication link, wherein the generated key performance indicator data visually displayed in the dashboard report indicates a resolution of a performance problem of the customer system to the service expert; and
in response to an input from the service expert via the secure access communication link, schedules a resolution to the performance problem indicated by the visually displayed generated key performance indicator data for implementing by the customer system.

10. The diagnostic system of claim 9, wherein the diagnostic system is contained within a device infrastructure container, and wherein the program instructions stored on the tangible computer-readable storage medium cause the processing unit to provide a plurality of different automated service tools comprising the automated service tool and that each receive different data formats comprising a first data format and a second data format that is different from the first data format, wherein the automated service tool is appropriate to receive and process the first data format and another of the plurality of different automated service tools is appropriate to receive and process the second data format;
wherein the customer system is comprised within a plurality of different customer systems that are each physically located within the customer facility and each in secure communication with the diagnostic system via the tunnel connection, and the received customer data comprises first data from a first of the customer systems in the first data format and second data from a second of the customer systems in the second data format; and
wherein the processing unit, when executing the program instructions stored on the tangible computer-readable storage medium via the computer readable memory, further generates the key performance indicator data by generating first key performance indicator data associated with the first system associated with the first data in the first data format via application of the automated service tool, and generates second key performance indicator data associated with the second system associated with the second data in the second data format via application of another automated service tool that is appropriate to second data format.

11. The system of claim 10, wherein the processing unit, when executing the program instructions stored on the tangible computer-readable storage medium via the computer readable memory, transforms the received customer data into a data report that is informative of a process performance without providing direct access for the service expert to the received customer data.

12. The system of claim 10, wherein the processing unit, when executing the program instructions stored on the tangible computer-readable storage medium via the computer readable memory, further:
automatically generates an automated resolution as the indicated resolution in response to determining that the performance gap between the generated key performance indicator data and the performance benchmark exceeds the threshold; and
generates an event trigger alert to the service expert or customer and schedules the automatically generating automated resolution for implementing by the customer system in response to the determined performance gap exceeding the threshold; and
wherein the input from the service expert via the secure access communication link, validates or intervenes in the scheduled implementation.

13. The system of claim 12, wherein the processing unit, when executing the program instructions stored on the tangible computer-readable storage medium via the computer readable memory, analyzes the generated key performance indicator data to determine the performance gap between the generated key performance indicator data and the performance benchmark by using a mathematical model to capture a performance gap between a good visualized performance and a bad visualized performance.

14. The system of claim 13, wherein the first and second customer systems are different services chosen from a plurality of services comprising system configuration, and ordering, system optimization, process optimization, condition monitoring, event notification, support services, alarm and event notification, control tuning, software support, system health checks and remote troubleshooting services.

15. The system of claim 14, wherein the automated tool and the another automated tool are different tools chosen from a plurality of tools comprising:
a machine-direction analyzer that provides automated analysis of process controls that control linear parameters in a production process;
a cross-direction analyzer that provides automated analysis of process controls that control cross-linear parameters in a production process; and
a service management tool that applies best practices as a function of historical information data.

16. An article of manufacture, comprising:
a computer-readable tangible storage medium having computer readable program code embodied therewith, the computer readable program code comprising instructions that, when executed by a computer processing unit, cause the computer processing unit to:
receive customer data from a system of a customer via a secure communication tunnel connection to the customer system, wherein the customer system is physically located within the customer facility;
generate key performance indicator data associated with the customer system from the received customer data via application of an automated service tool that is appropriate to a format of the received data;
display the generated key performance indicator data in a visual display format that indicates a performance quality attribute of the generated key performance indicator data with respect to a performance benchmark;
in response to the determined performance gap exceeding a threshold, visually display the generated key performance indicator data in a graphical user interface dashboard report to a service expert that is in a remote location that is physically remote from the customer facility and the container infrastructure and in communication with the container infrastructure via a secure access communication link, wherein the generated key performance indicator data visually displayed in the dashboard report indicates a resolution of a performance problem of the customer system to the service expert; and
in response to an input from the service expert via the secure access communication link, schedule a resolution to the performance problem indicated by the visually displayed generated key performance indicator data for implementing by the customer system.

17. The article of manufacture of claim 16, wherein the customer system is a plurality of different systems that are each physically located within the customer facility, and the received customer data comprises data from a first system of the plurality of the different systems in a first data format and data from a second system of the plurality of the different systems in a second data format that is different from the first data format, and wherein the automated service tool is appropriate to first data format; and
wherein the computer readable program code instructions, when executed by the computer processing unit, cause the computer processing unit to generate the key performance indicator data by generating first key performance indicator data associated with the first system associated with the first data in the first data format via application of the automated service tool, and to generate second key performance indicator data associated with the second system associated with the second data in the second data format via application of another automated service tool that is appropriate to second data format.

18. The article of manufacture of claim 17, wherein the computer readable program code instructions, when executed by the computer processing unit, further cause the computer processing unit to transform the received customer data into a data report that is informative of a process performance without providing direct access for the service expert to the received customer data.

19. The article of manufacture of claim 18, wherein the computer readable program code instructions, when executed by the computer processing unit, further cause the computer processing unit to:
automatically generate an automated resolution as the indicated resolution in response to determining that the performance gap between the generated key performance indicator data and the performance benchmark exceeds the threshold; and
generate an event trigger alert to the service expert or customer and schedules the automatically generating automated resolution for implementing by the customer system in response to the determined performance gap exceeding the threshold; and
wherein the input from the service expert via the secure access communication link, validates or intervenes in the scheduled implementation.

20. The article of manufacture of claim 19, wherein the automated tool and the another automated tool are different tools chosen from a plurality of tools comprising:
a machine-direction analyzer that provides automated analysis of process controls that control linear parameters in a production process;
a cross-direction analyzer that provides automated analysis of process controls that control cross-linear parameters in a production process; and
a service management tool that applies best practices as a function of historical information data.
